(19) United States
(12) Patent Application Publication
(10) Pub. No.: US 2008/0082602 A1
(43) Pub. Date: Apr. 3, 2008

(54) Request transmission control apparatus and method

(75) Inventor: Ikuya Morikawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/790,895

(22) Filed: Apr. 27, 2007

(30) Foreign Application Priority Data
Sep. 28, 2006 (JP) 2006-264863

(51) Int. Cl. G06F 15/16

(52) U.S. Cl. 709/203

(57) ABSTRACT

When request transmission is performed, a window selection section of this apparatus selects a window to handle the request based on a partition table. Then, if a relevant window does not exist, a window creation section creates a window based on a partitioning setting table. In the case of a response obtained from an access destination of request transmission which does not belong to the window partition of the request source, a request checking section refuses the request transmission or notifies the user to that effect. Alternatively, a request editing section changes and transmits the contents of the request transmission.

### CROSS-REFERENCE TO RELATED APPLICATIONS

This application claims priority from Japanese patent application Serial no. 2006-264863 filed Sep. 28, 2006, the contents of which are incorporated by reference herein.

### BACKGROUND OF THE INVENTION

1. Field of the Invention

The present invention relates to a function of classifying page groups into partitions according to URL's (uniform resource locators) of sites to be access destinations or periods during processing by a WWW (World Wide Web) browser (Web browser) to restrict transmission of a request from outside the partition.

2. Description of the Related Art

Recently, client/server applications based on Web techniques, that is, Web applications have been widely used. These are applications which perform communication on a network based on the HTTP (Hypertext Transfer Protocol) protocol, and the screen contents (pages) presented to a user are described mainly in the HTML (Hypertext Markup Language) format.

The Web in the past is mainly intended to simply provide static information to clients. Recently, however, a lot of dynamic applications, for example, processing for submitted information such as in bulletin boards or weblogs (blogs), management of equipment connected to a network, and commercial transactions such as purchase of goods and services are realized by the Web techniques and are widespread in the society.

A server is also referred to as a Web site, and mainly a Web browser is used for a client. As typical Web browsers, Internet Explorer by Microsoft Corporation and Firefox by Mozilla Foundation exist.

A lot of high-level Web applications are required to provide information or permit an operation only for particular users. Therefore, security functions are prepared, such as HTTPS (Hypertext Transfer Protocol over SSL) protocol in which protection is provided by SSL (Secure Sockets Layer) or TLS (Transport Layer Security) and HTTP authentication.

However, the HTTP protocol is stateless and does not have a function of associating multiple pairs of a request and a response with one another itself. Therefore, there is provided a mechanism referred to as a cookie. The cookie is a technique in which a Web browser implicitly holds data specified by a server to perform transmission by adding the value each time a request is made. Thereby, a Web server can identify pairs of a request and a response as exchanged with the same Web browser.

Meanwhile, a Web browser is provided with a function of controlling the browser's own behavior based on specification supplied by the Web server side in order to realize complicated processing and provide high-level appearance and functions for a user.

A client-side script, which is one of such functions, is a simple program language which can be described in an HTML page or in a file referred to from within an HTML page, and it can control the behavior of a Web browser to some extent. The most typical client-side script is JavaScript. As its variations and similar scripts, ECMAScript, JScript, VBScript and the like exist. Here, JavaScript is used to refer to all of them.

Such functions are also realized by using only the HTTP and the HTML without JavaScript: embedding images and other objects into an HTML page, redirection by the HTTP, automatic page refresh by META tags of the HTML and the like. These can also control the behavior of a Web browser to some extent.

Such Web browser control functions are convenient to a Web application provider. Meanwhile, the functions are also convenient to an attacker who attempts to slip through the security functions of a Web application and violate the security. The attacker can operate a user's Web browser and make an attack by preparing an HTML page advantageous to himself at any site and causing the user to open the page. In order to cope with such an attack, protection mechanisms such as Same Origin Policy (SOP) and zoning are provided for Web browsers.

The SOP, one of the protection mechanisms, restricts the functions of JavaScript. Thereby, JavaScript can refer to or operate only the object tree of such a page that is acquired from the same server (i.e., “same origin”) as the page with which the JavaScript is associated is acquired. Due to the restriction, information included in HTTP responses which have been obtained from different servers can be mutually protected from JavaScript of the counterpart. The SOP is prepared for almost all Web browsers that provide the JavaScript functions.

In the zoning, which is another protection mechanism, Web servers are classified into different zones in a Web browser according to predefined settings, and all or a part of the functions of JavaScript or the like are restricted for each zone. In Internet Explorer, this mechanism is provided in the name of “Security Zones”, and Web servers are classified into multiple zones, that is, “Internet”, “Local Intranet”, “Trusted Sites”, “Restricted Sites” and “Local Machine” zones.

Though explicit zoning settings cannot be made in Firefox (at least for the current Version 1.5 and older versions), a zoning function called “site policy” is already prepared, and settings can be made therefor by adding an extended capability called “Policy Manager Extension”. This extension makes it possible to create any zone in the unit of one site at a minimum. Based on these zones, Firefox can restrict the functions of JavaScript and the like based on the zones, as similar to Internet Explorer.

However, even if the protection mechanisms as described above are provided, protection of a Web browser is not sufficient. It is because an attacker can still force a Web browser to send a request to any site by a tailored HTML page. This implies that the following attack techniques can be realized.

First, an attacker can freely specify the values of parameters of a query or a form accompanying a request. However, since it is necessary to explicitly specify the values, the attacker must know the values. Next, the attacker cannot specify nor know the cookie accompanying the request. However, values stored in the Web browser are automatically transmitted. That is, the browser transmits the cookie which only the user knows in response to an instruction from the attacker. As a result, the attacker can force the browser to send the cookie which only the user knows.

Various threats are conceivable which may be caused by such forced request transmission. The most typical threat is the threat of an attack called cross-site request forgery (CSRF). In CSRF, a Web browser transmits a request for requesting important processing in an application in response to an instruction from an attacker. The important processing is, for example, writing/deletion of a message, purchase of articles, application for services and the like. There is a risk of such important processing being requested by CSRF irrespective of the intention of the user. Especially when a user is recognized by a cookie, serious damage may be caused.

The SOP only inhibits reference to a response obtained from a different site and cannot inhibit transmission of a request to a different site itself. Zoning restricts a part or all of browser control functions, such as those of JavaScript, and therefore, it can prevent request transmission which is not desired by a user if appropriate settings are made therefor. However, in the current actual situation of application of Web techniques, it is impractical to restrict the browser control functions for most of sites because convenience is impaired.

Furthermore, there is a possibility that a request which is not intended by a user may be transmitted by the user's careless mistake or subtle induction by an attacker. For example, a user may be damaged by a request generated by the user's operation of following a hyper-link, submitting a form or the like unless the user sufficiently understands the influence of the request before performing the operation.

Such request transmission that may cause a threatening result is collectively referred to as “forced request transmission” hereinafter. The following countermeasure techniques exist to cope with the “forced request transmission”.

(1) Countermeasure Technique: Various Functions of Browser

Some Web browsers have a function of restricting even transmission of a request. First, HTTPS sites (sites protected by SSL or TLS) are specially treated. A lot of browsers are provided with a function of, for such sites, refusing or warning about transmission of a request between different HTTPS sites and between an HTTPS site and a non-HTTPS site. Thereby, in the case where an important site is provided only by HTTPS, it can be said that the threat of the forced request transmission is reduced.

Furthermore, Internet Explorer is also equipped with a function of issuing a warning when transmission of a form is redirected by a server to a different server.

(2) Countermeasure Technique: NoGET Extension for Firefox

The extension called NoGET for Firefox provides a function of deleting query parameters from a GET method request in the case of following a hyper-link. This partially reduces the threat of the forced request transmission.

(3) Counter Measure 3: Access Control Techniques by Microsoft Corporation

As access control techniques for general programs operating on an OS, techniques of Patent Document 1 (National Publication of International Patent Application No. 2002-517852 (US09/097,218)) and Patent Document 2 (Japanese Patent Laid-Open No. 2004-310774 (US10/405,972)) exist, though they are not limited to Web browsers. Patent Document 1 discloses a technique for performing access control for each process, which is a unit of execution of a program, to prevent a particular process from communicating with a particular site. Patent Document 2 discloses a technique for performing similar access control in the unit of program installation. By making appropriate access control settings for each process to be activated in the case of Patent Document 1 and for each installed program in the case of Patent Document 2, the forced request transmission can be prevented.

However, such existing techniques can solve only a part of the problem of the forced request transmission.

The various functions of a browser according to the countermeasure 1 may include a function of restricting request transmission. However, the actually implemented processing function is not complete because it cannot restrict all cross-boundary requests. For example, Internet Explorer is equipped with a function of giving a warning when transmission of a form is redirected by a server to a different server, this can only prevent a slight part of the threat of the forced request transmission.

NoGET of the countermeasure technique 2, which is an extension for Firefox, is applicable only in the case of deleting query parameters from a GET method request. Therefore, an attacker can easily avoid this. That is, threats by requests other than the GET request or threats not by query parameters are not reduced.

Furthermore, between the access control techniques of the countermeasure technique 3, appropriate access control settings are made for each process to be activated in the case of the technique of Patent Document 1 and for each installed program in the case of the technique of Patent Document 2, and therefore, it is not possible to perform detailed control in conjunction with the behavior specific to a Web browser in neither of the techniques.

In Patent Documents 1 and 2, it is necessary to determine start of protection in advance before performing an operation of activating a process at the OS level or installing a browser. Therefore, it is not possible to start protection from the forced request transmission in response to an event of, for example, following a link to a particular site or receiving a particular response.

Furthermore, in Patent Document 1, as for separation of information resources such as HTML page data, cookies and authentication information, information stored in a short-term storage area allocated for each process is separated, while information stored in a long-term storage area, such as a file and a registry (non-volatile information such as cookies and caches) is not separated and is shared. In Patent Document 2, though information in both of the short-term storage area and the long-term storage area is separated, it essentially requires the same troublesome work as preparation of multiple Web browsers.

As described above, the threat of the forced request transmission exists in a Web application. However, the above countermeasure techniques cannot sufficiently cope with the threat, and there are problems, such as that only a part of the threat can be avoided or reduced and that the techniques are significantly inconvenient in practical use.

### SUMMARY OF THE INVENTION

The object of the present invention is to provide a client apparatus capable of restricting forced request transmission which may pose a threat to a user.

The present invention is a program product, an apparatus and a method for controlling request transmission to an access destination, and includes a function of classifying resources at access destinations, that is, per server or more detailed resource location into one or more partitions based on predetermined conditions, and a function of, for any of the partitions, when request transmission to an access destination belonging to the partition is instructed by an HTTP response and its body contents obtained from an access destination which does not belong to the partition, executing one or more processings such as refusing the request, notifying a user thereof, prompting a user to make determination and changing a part of information included in the request. The “partition” is a classified section for an access destination isolated based on a predetermined condition, and the isolation of an access destination into a partition is referred to as “partitioning”. The partitioning is performed by being triggered by HTTPS, HTTP authentication, presence of a password field in a form, transmission of a Cookie header, receiving of a Set-Cookie header, presence of a special attribute of a Set-Cookie header and the like. Thereby, request transmission beyond the boundary between the access destination partitions can be restricted.

According to the present invention, the client apparatus is provided with a function of isolating and storing information associated with an access destination (such as cookies and authentication information) in a corresponding partition. Thus, page data, cookies, authentication information and the like for each access destination is isolated in each partition, and thereby, mutual access between different partitions can be restricted.

Furthermore, the present invention may include a function of, when request transmission of information associated with a corresponding partition is instructed, transmitting the request after editing the request so that the information is not included. Thereby, it is possible to perform request transmission with information which may damage a user excluded.

The present invention operates as described below.

The client apparatus of the present invention typically realized as a Web browser performs processing for separating access destinations into one or more partitions based on a predetermined condition (partitioning). The condition of partitioning is basically correspondence with all or a part of an access destination URL (information constituted by a protocol name, a hostname, a port number and a path). The temporal expiration, such as the time and date, existence of a particular cookie or existence of authentication information may be included as a condition.

Then, if request transmission to an access destination belonging to a certain partition is requested, and the request instruction source is a response obtained from an access destination which does not belong to the partition, the request transmission is restricted. Specifically, the request transmission may be simply refused as the restriction. Information may be presented to the user to prompt the user's determination, or a part of the request may be changed before transmission.

Furthermore, information used being associated with an access destination, such as cookies and authentication information, is held for each of the partitions. When request transmission beyond the partition is requested, the request is edited so that information associated with the partition is not included, and the edited request is transmitted.

Furthermore, in order to avoid the troublesome work of setting partitioning conditions in advance, a partition is created when distinctive characteristics of a Web site for performing important processing are found and dynamically determining a condition. For example, when a session cookie is issued from a server, a partition having a condition corresponding to the effective range of the cookie (the access destination and the expiration time and date) is created being triggered thereby.

Similarly, when HTTP authentication, such as Basic Authentication and Digest Authentication, is requested by a Web server, a partition having a condition corresponding to the authentication range (called a realm) is created.

If a response including a password field, which is often used for the purpose of authentication, is obtained, and the user uses the password field and transmits a form including the password field, then a partition having a condition corresponding to the access destination from which the response concerned has been obtained or the access destination of the request to be transmitted is created.

Since setting of restrictions on request transmission based on partitions and partitioning conditions is troublesome or difficult, the convenience can be enhanced by the processing described above.

The client apparatus of the present invention can be realized by a software program installed in a computer and executed. The program can be stored in a suitable recording medium such as a computer-readable portable medium memory, a semiconductor memory and a hard disk. The program is provided being recorded in such a recording medium, or it is provided by transmission/receiving using various communication networks via a communication interface.

According to the present invention, a request beyond the boundary between partitions separated based on predetermined conditions is restricted before being transmitted, and the transmission may be refused or performed from within a different partition in accordance with presettings or the user's determination. Thereby, it is possible to prevent important request transmission to a “trusted site” from being performed based on a request from outside a partition into the partition, for example, a request from an “untrusted site”.

Since cookies and HTTP authentication information used for a trusted site are not used, a request can be transmitted more safely.

Furthermore, even if partitioning settings are not made in advance, the convenience can be enhanced by performing partitioning automatically or semi-automatically when a sign of access to an important site, that is, an event, such as start of access to a certain HTTPS site, transmission/receiving of a certain kind of cookie, transmission/receiving of HTTP authentication information and transmission/receiving of a value in a password field, occurs.

### BRIEF DESCRIPTION OF THE DRAWINGS

FIG. 1 shows an example of the configuration of a computer in which the present invention is embodied;

FIG. 2 shows the configuration of general functions of a Web browser and main data;

FIG. 3 shows the functional block configuration of a Web browser of the present invention and data;

FIG. 4 shows an example of a partition table;.

FIG. 5 shows an example of specification of long-term storage data in a file system of a disk;

FIG. 6 shows an example of a partitioning setting table;

FIG. 7 shows an example of a window table;

FIG. 8 shows an example of a case where multiple windows w1 to w4 . . . are displayed by the Web browser;

FIG. 9 is a flowchart of request checking processing;

FIGS. 10 and 11 are a flowchart of window selection processing;

FIG. 12 is a flowchart of partition creation processing;

FIG. 13 is a flowchart of window creation processing;

FIG. 14 shows an example of a screen for a user to perform an interactive operation; and

FIGS. 15 and 16 are diagrams for illustrating the operation of the present invention.

### DETAILED DESCRIPTION OF THE PREFERRED EMBODIMENT

An embodiment of the present invention will be described as an application program similar to a conventional, general Web browser, which operates on an operating system (OS) of a general-purpose computer.

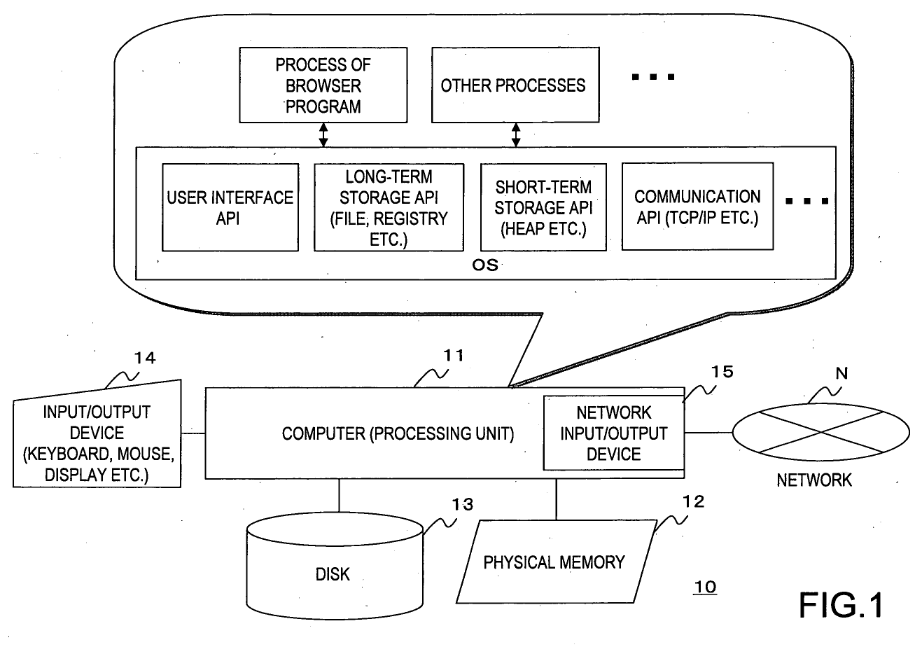

FIG. 1 shows an example of the configuration of a computer in which the present invention is embodied. A computer 10 in FIG. 1 is provided with an processing unit 11, a physical memory 12 which is a volatile storage area, a disk 13 which is a non-volatile storage area, an input/output device 14 such as a keyboard, a mouse and a video display, an input/output device 15 to a network N, and the like.

An operating system (OS) and various application programs operate on the computer 10. The OS provides the functions of the various devices in the form of a system call or an API to process execution control (scheduling), short-term storage such as a heap, long-term storage such as a file and a registry, a communication function by TCP/IP, a graphical user interface (GUI) based on a window system and the like. The embodiment of the present invention is not limited to the above configuration, and it may be realized as a computer with a non-graphical user interface or a simple terminal device exclusively used as a browser.

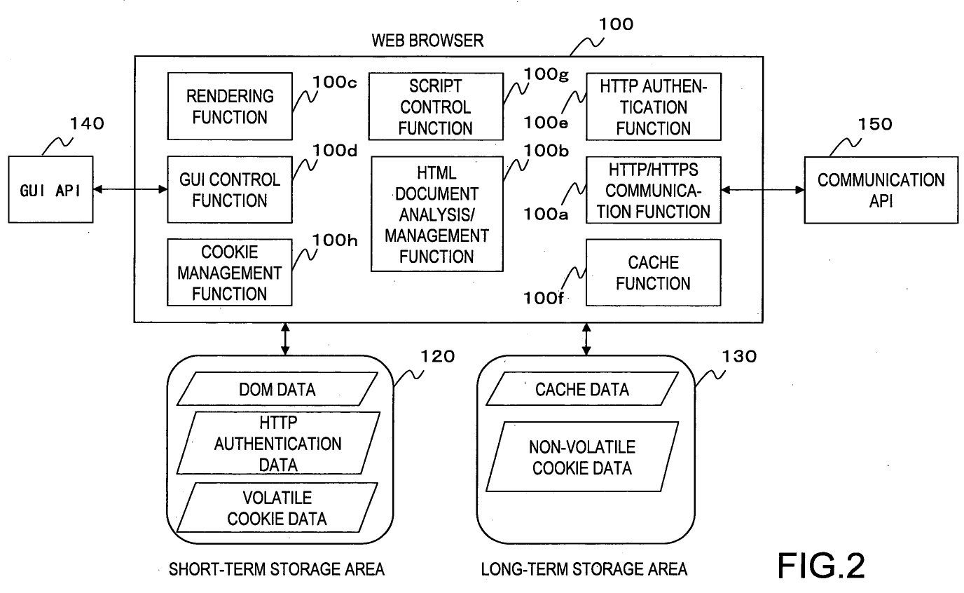

FIG. 2 shows the configuration of general functions of a Web browser and main data.

The main functions of the Web browser 100 are an HTTP/HTTPS communication function 100a, an HTML document analysis/management function 100b, a rendering function 100c and a GUI control function 100d. These functions realize communication with a server by the HTTP protocol, interpretation, management and screen display of an HTML document, the main contents of the communication, and interactive operation with a user, in cooperation with a communication API 150 and a GUI API 140 provided by the OS. In most cases, the Web browser 100 can display multiple Web pages at a time with the use of areas called windows or tabs (hereinafter, simply referred to as windows). Furthermore, in general, an HTTP authentication function 100e, a cache function 100f, a script control function 100g, a cookie management function 100h and the like are also provided.

In a short-term storage area 120 such as a heap memory, data which is held only while the Web browser 100 is operating is stored. Such data in the short-term storage area 120 (short-term storage data) includes DOM (document object model) data which is the result of interpretation of an HTML document, HTTP authentication data in which a user ID and a password inputted by a user (or a product generated from inputted data) is held, and volatile cookie data in which cookie information received from a server is held.

In a long-term storage area 130 such as a file and a registry, data is stored which is continuously held even after the Web browser 100 stops operating. Such data in the long-term storage area 130 (long-term storage data) includes cache data and non-volatile cookie data.

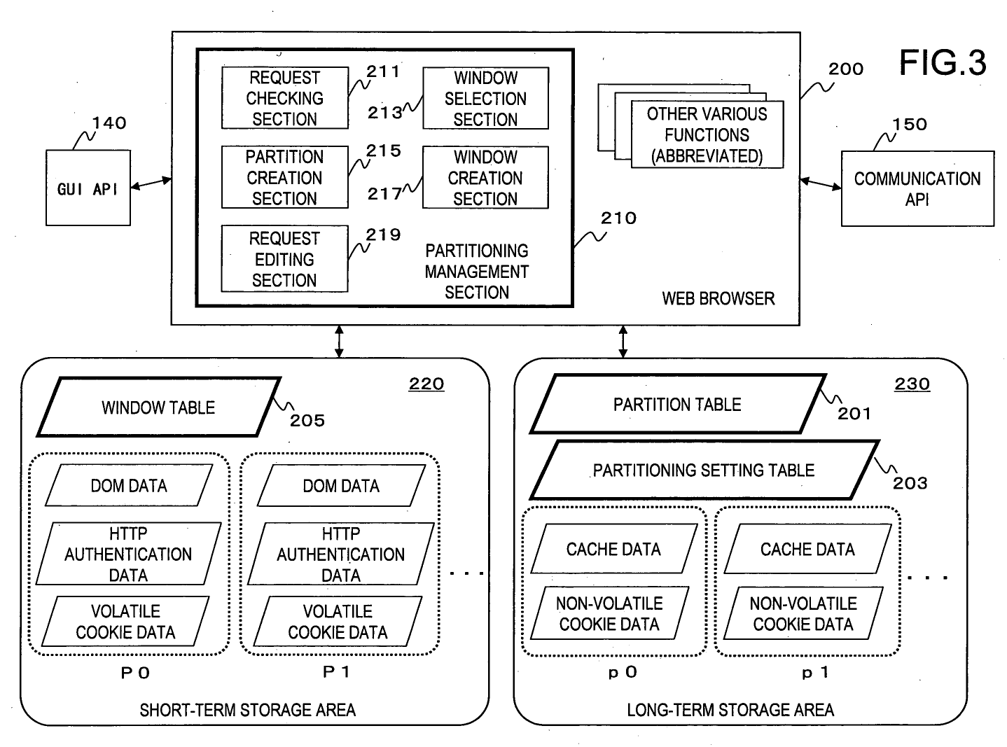

FIG. 3 shows the functional block configuration of a Web browser 200 of the present invention and data. In the configuration in FIG. 3, the same functions as those of the Web browser 100 in FIG. 2 are shown in abbreviation.

The Web browser 200 is provided with a partition table 201, a partitioning setting table 203, a window table 205 and a partitioning management section 210.

The partition table 201 and the partitioning setting table 203 are provided in a long-term storage area 230. The window table 205 is provided in a short-term storage area 220.

The partitioning management section 210 is provided with a request checking section 211, a window selection section 213, a partition creation section 215 and a window creation section 217.

The above-described request determination processing of the present invention is performed by the request checking section 211. Partitioning means is embodied by the window selection section 213, the partition creation section 215 and the window creation section 217. Request editing processing is realized by a request editing section 219.

The Web browser 200 has equivalent processing functions in comparison with the functions and the data structure of the general Web browser 100 shown in FIG. 2. However, it is different from the Web browser 100 in having the following characteristics.

(a) It has multiple partitions.

(b) One partition is associated with each window.

(c) Short-term storage data (DOM data, authentication information, volatile cookies and the like) and long-term storage data (non-volatile cookies, caches and the like) are managed for each partition.

(d) Processing performed within each window is performed with the use of short-term storage data and long-term storage data allocated to a partition corresponding to the window.

(e) When a request transmission event occurs, partition boundary check is performed based on the window where the event has occurred, and a request which crosses between partitions is restricted.

The above characteristic (a) is realized by the partition table 201 of the Web browser 200, the characteristic (b) by the window table 205, the characteristic (c) by the short-term storage area 220 and the long-term storage area 230 each of which is managed being separated to correspond to partitions P0, P1, . . . , and characteristics (d) and (e) by the partitioning management section 210.

Next, the data definition in the Web browser 200 will be described.

In this embodiment, the “partition” is a classification of a Web page based on some condition. The condition of the classification of the partition is basically defined with regard to the characteristic of a request for acquiring the Web page.

P is a set of all partitions p existing on the Web browser 200 at a certain point of time.

P={p1, p2, . . . , pn}

Here, p1, p2, . . . , pn are partition identifiers for uniquely identifying the respective partitions, where n is the number of partitions existing at that point of time, and n=0 is possible. In this case, P is an empty set.

P′ is a set obtained by adding a particular partition identifier p0 to P.

P′={p0}∪P

where p0 is an indication of not being included in any of the partitions. P′ is a set which always changes following P. For example, if an element p is added to the set P, then it is considered that the set P′ has also been automatically added with p.

W is a set of all windows w existing on the Web browser 200 at a certain point of time.

W={w1, w2, . . . , wm}

Here, w1, w2, . . . , wm are window identifiers for uniquely identifying the respective windows, wherein m is the number of windows at that point of time. At the initial state, m=0 is possible. In this case, W is an empty set.

W′ is a set obtained by adding a particular window identifier w0 to W.

W′={w0}∪W

where w0 is an indication of not belonging to any of the windows. For example, it is used when request transmission is requested from a place other than any windows of the Web browser 200, such as the OS or the other applications. W′ is a set which always changes following W. For example, if an element w is added to the set W, then the set W′ has also been automatically added with w.

Each window w is necessarily associated with one partition identifier p. That is, it is assumed that a map f′: W->P′ exits.

Furthermore, a map f′: W′->P′ is defined which has been extended so that w0 can be handled. However, f′(w0)=p0 is always satisfied, and this means that not being any of the windows is treated as not belonging to any of the partitions.

A condition cond(p) for belonging to a partition p is defined in any pεP′. Creation conditions newcond for creating a new partition is also defined.

The set of windows W is to be naturally held by a conventional function of the Web browser 200 and may not be held.

Next, the components of the Web browser 200 will be described.

The partition table 201 is a storage section for storing information indicating the set of partitions P and the conditions cond(p).

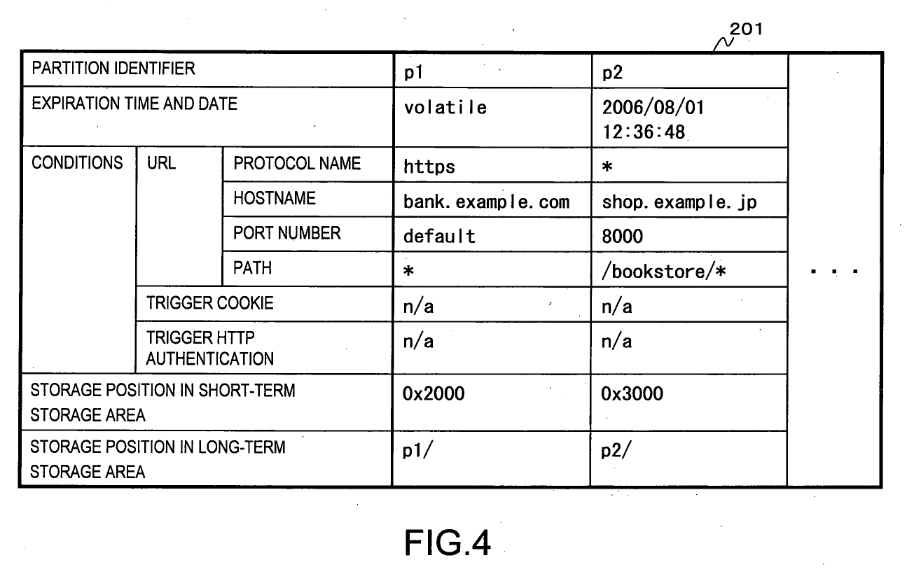

FIG. 4 shows an example of the partition table 201. In the partition table 201, one row is allocated to each partition, and a partition identifier, the expiration time and date, conditions, the storage position in the short-term storage area and the storage position in the long-term storage area are held in each row.

Any value can be used as an actual representation of the partition identifier if each partition can be uniquely identified by the value.

The expiration time and date refers to the expiration time and date of the partition. It takes any value among a value concretely specifying the time and date, “volatile (effective only until the Web browser 200 ends processing)” and “n/a (not applicable; without expiration)”.

The storage position in the short-term storage area specifies the position of data (such as a volatile cookie) in the short-term storage area 220, corresponding to the partition. As shown in FIG. 4, the storage position in the short-term storage area is indicated, for example, by an offset (a value of difference) from a particular memory address shown in hexadecimal.

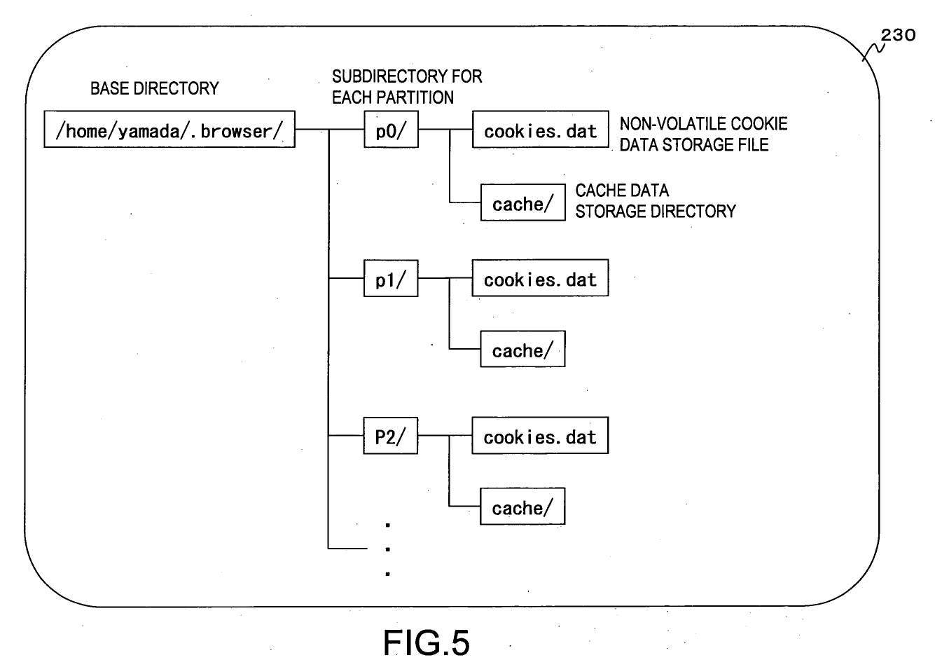

The storage position in the long-term storage area specifies the position of data (such as a non-volatile cookie) in the long-term storage area 230, corresponding to the partition. For example, in the disk file system shown in FIG. 5, if long-term storage data is stored by providing a sub-directory for each partition under a predetermined base directory, the storage position in the long-term storage area is indicated by a relative path from a particular directory path as shown in FIG. 4.

The condition items in the partition table 201 specify the condition cond(p). In FIG. 4, a condition of URL, which is a basic condition, and conditions of a trigger cookie and trigger HTTP authentication, which are supplementary conditions, are held.

The condition of URL are constituted by four items of protocol name, hostname, port number and path. Each item is checked against its corresponding portion of a URL. In the respective condition items, the values as shown below is set. The special value “*” means a wild card which indicates that any value is considered to satisfy the condition.

Protocol name: “http”, “https” or “*”;

Hostname: a fully-qualified hostname, a hostname a part of which is replaced with “*”, or “*”;

Port number: an integer between 0 and 65535, “*”, or a special value “default (which means a condition that port number specification must not exist in the URL)”;

Path: an absolute pathname beginning with “/”, a pathname a part of which is replaced with “*”, or “*”.

The item of the trigger cookie in the partition table 201 is for specifying a cookie to be used in partition creation processing by a function of being triggered by a cookie to be described later. For this item, “n/a (which means that this condition is not used)” or a concrete cookie condition described below is stored.

As the cookie condition, a cookie name followed by a list of zero or more options separated by semicolons is described.
<cookie name>[;<option>[;<option>[ . . . ]]]

The cookie name is any cookie name. The option takes the form of:
<option name>=<option value>

### The following are effective option names.

domain: If there is an applicable domain for a cookie, the value is taken.

port: If there is an applicable port number for a cookie, the value is taken.

path: If there is an applicable path for a cookie, the value is taken.

secure: If secure is specified for a cookie, “true” is set as the value.

For example, the following are examples of the value for the item of the trigger cookie.

JSESSIONID

ASPSESSIONID; secure=true

PHPSESSID; domain=shop.example.jp; path=/bookstore/

It is assumed that the condition of this item is satisfied when a request is going to transmit a relevant cookie.

For the item of the trigger HTTP authentication in the partition table 201, HTTP authentication specifications to be used in partition creation processing by a function of being triggered by HTTP authentication to be described later is specified. For this item, “n/a (which means that this condition is not used)” or the list separated by semicolons shown below is set.

“Kind of HTTP authentication (“basic” or “digest”); “authentication realm name (any character string surrounded by quotation marks); username (any character string); authentication realm path (absolute path beginning with “/”; optional)”

When the authentication realm path is omitted, the path is considered to be the same as the path item of the URL condition. The value for this item is, for example, a list as shown below.

basic; “Authorized users only”; yamada

digest; “Home directory”; suzuki; /home/suzuki/

It is assumed that the condition of this item is satisfied when a request is going to transmit a relevant HTTP authenticator.

The partitioning management section 210 checks the partition table 201 every time the Web browser 200 is activated and deletes a partition row which satisfies any of the following.

The expiration time and date is “volatile”, or the concretely specified time and date is older than the current time.

A concrete cookie condition is set for the item of the trigger cookie, and the relevant cookie is not stored in the Web browser 200 or the expiration time and date has been exceeded.

The partitioning setting table 203 is a storage section for storing information indicating the creation conditions newcond.

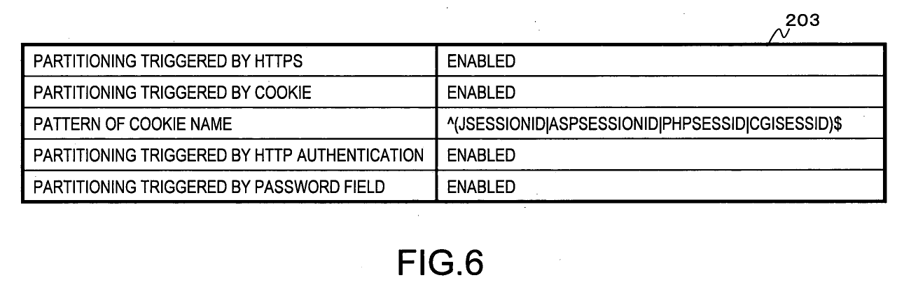

FIG. 6 shows an example of the partitioning setting table 203. In the partitioning setting table 203, settings about whether or not to enable each of four functions provided for the partition creation section 215 is stored.

The four functions are a function of being triggered by HTTPS, a function of being triggered by a cookie, a function of being triggered by HTTP authentication, and a function of being triggered by a password field. Each of the items corresponding to these functions takes any of the values “enabled” and “disabled”. Furthermore, minor setting information that is necessary or useful when each function is executed may be also included. In this embodiment, a cookie name pattern related to the function of being triggered by a cookie is set as the minor setting information.

In the partitioning setting table 203 shown in FIG. 6, the item of the cookie name pattern is specified by a regular expression as shown below.
“̂(JSESSIONID|ASPSESSIONID|PHPSESSID|CGISESSID)$”

This specification means the case where the name of a cookie completely corresponds to any of the four specifications within the parentheses which are separated by vertical bar symbols (“|”).

As another specification method, the following is given, for example.
“(?i)sess(ion)?id$”

### This specification means that the cookie name ends with “sessid” or “sessionid”. Here, “(?i)” is for an option for specifying that difference between uppercase and lowercase letters is ignored (case-insensitive) is enabled in a regular expression.

It is when any of the functions of being triggered, of the partition creation section 215 is effective, and a request satisfies the condition for each of the functions that the creation conditions newcond are satisfied under the data set in the partitioning setting table 203.

The window table 205 is a storage section for storing information indicating correspondence relation between the set of windows W and the map f, that is, between each window w and each partition p.

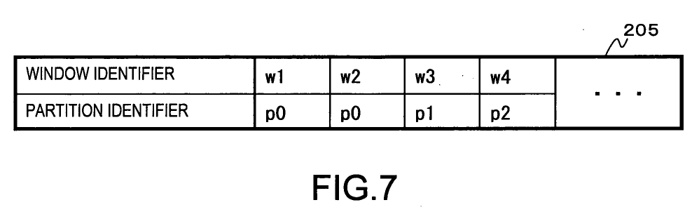

FIG. 7 shows an example of the window table 205. In the window table 205, each row corresponds to each window. Each row is constituted by a window identifier and a partition identifier.

The window identifier is a value which can uniquely identify each window. In general, a value provided by a system (such as a window handle) can be used.

The partition identifier is any of partition identifiers described in the partition table.

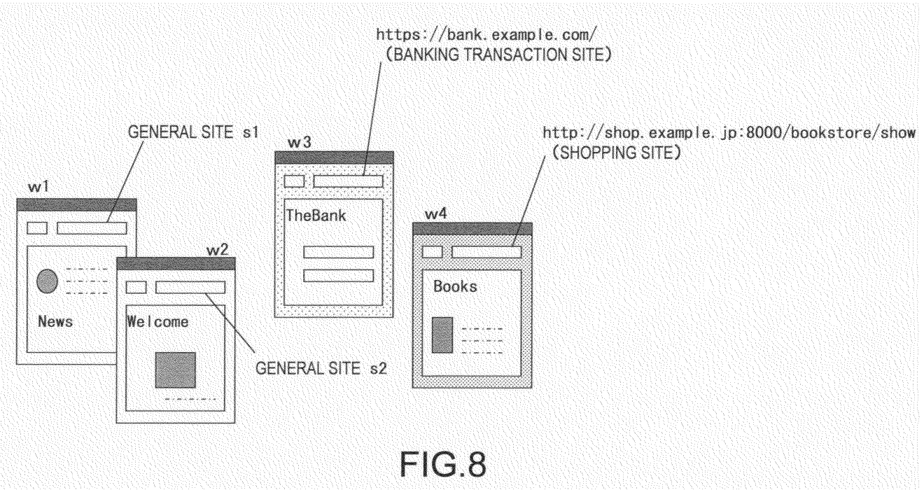

It is assumed that multiple windows w1 to w4, . . . are displayed by the Web browser 200 as shown in FIG. 8. In this case, the access destinations of the windows w1 and w2 are general sites and do not satisfy any of the conditions of the partitions p1 and p2. Therefore, the partitions for them are identified as the partition p0, and “p0” is set in the relevant rows in the window table 205.

As for the window w3, the protocol name is “https”, the access destination hostname is “bank.example.com”, and the condition of the partition p1 is satisfied. Therefore, “p1” is set in the relevant row in the window table 205. As for the window w4, the access destination hostname is “shop.example.jp”, the pathname is “[bookstore/*”, and the condition of the partition p2 is satisfied. Similarly, “p2” is set in the relevant row in the window table 205.

The data in the partition table 201 and the window table 205 is changed in accordance with the result of processing by the partitioning management section 210 as appropriate.

Next, the operation principle of the present invention will be described.

For each window wεW, the Web browser 200 uses the data in the short-term storage area 220 and the long-term storage area 230 assigned to a partition p=f(w) corresponding to the widow w to perform request transmission, interpretation and retention of a response, operation of a script and the like. Therefore, data of the other partitions are not used. For example, even if a cookie to be transmitted to a certain server is stored in a short-term storage area 220 or a long-term storage area 230 assigned to a different partition, the Web browser 200 does not transmit the cookie and transmits only other cookies in the partition assigned to the window w itself. If there is no such cookie, nothing is transmitted.

The partitioning management section 210 is provided with a request checking section 211, a window selection section 213, a partition creation section 215, a window creation section 217 and a request editing section 219.

If a request transmission event is caused by processing, such as clicking a link, pressing a form submit button, and request transmission being requested by an embedded object or JavaScript, within a certain window, the partitioning management section 210 performs partition boundary check processing before transmission of the request.

Here, the request required to be transmitted is denoted by r, and the window where the event has occurred is denoted by wsεW′.

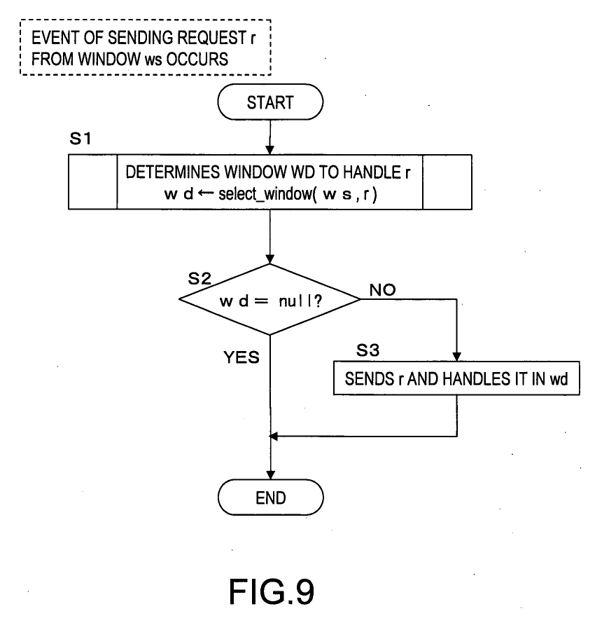

FIG. 9 shows a flowchart of request checking processing. The request checking section 211 performs the following processing by the check_request algorithm.

When an event of transmitting the request r from the window w occurs, the request checking section 211 first performs window selection processing (to be described later) and determines a window wd to handle the request r (step S1).

It is checked whether the value of the window wd is a special value (null) (step S2). If the window wd is the special value (null) (step S2: YES), then the processing is ended because the request r should not be transmitted. If the window wd is not the special value (null) (step S2: NO), then the Web browser 200 transmits the request r with the window wd. After that also, the short-term storage data and the long-term storage data assigned to the partition p=f(wd) corresponding to the window wd are used to perform transmission of a request r, interpretation and retention of a response, operation of a script and the like (step S3).

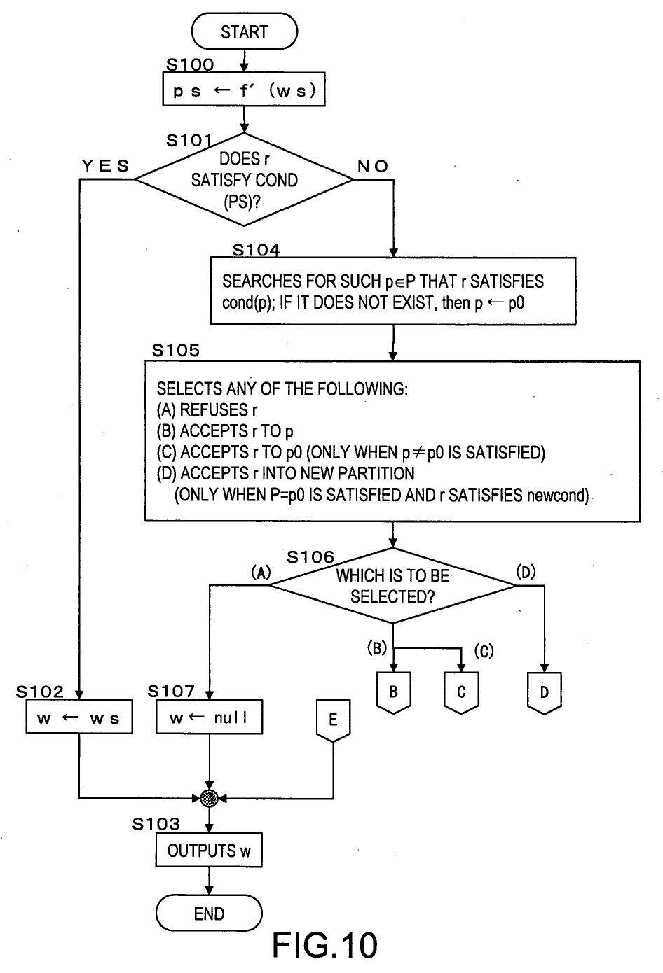

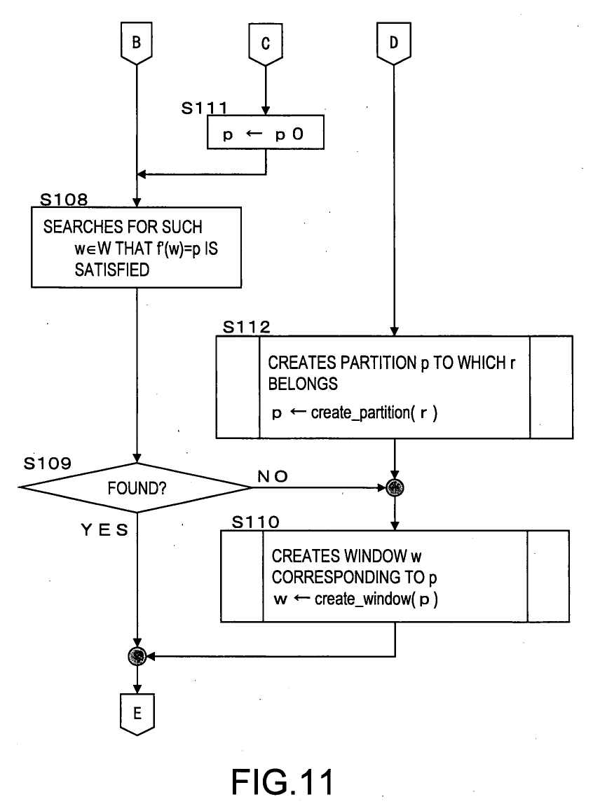

FIGS. 10 and 11 show a flowchart of window selection processing. The window selection section 213 performs the following processing by the select_window algorithm.

The window selection section 213 first determines the partition ps<-f(ws) of an originating window ws (step S100). Next, it is checked whether a request r satisfies a condition cond(ps) (step S101). If the request r satisfies the condition cond(ps) (step S101: YES), then the request r can be handled within the window ws because the access destination belongs to the same partition as that for the originating window ws. Therefore, ws is substituted for w (step S102), w is outputted (step S103), and the processing is ended.

If the request r does not satisfy the condition cond(ps) (step S101: NO), then it is checked, for each partition pεP, whether the request r satisfies the condition cond(p) to search for such p that the request r satisfies the condition cond(p) (step S104). However, in the case of p=ps, the check has already been performed and can be omitted. If such p that the condition cond(p) is satisfied does not exist, then p0 is substituted for p. Though there is a possibility that there are multiple relevant p's, one p is selected by some method. For example, it is desirable to prevent the conditions from overlapping with one another by determining the order of priority in advance.

Here, the case where the request r does not satisfy the condition cond(ps) means the case where access is attempted by the request r to an access destination belonging to a partition p different from the originating partition ps. The window selection section 213 selects any of the following options by some method (step S105).

Option (A): Refuses the request r.

Option (B): Accepts the request r to the partition p.

Option (C): Accepts the request r to the partition p0 (selectable only when p≠p0 is satisfied).

Option (D): Accepts the request r to a new partition (selectable only when p=p0 is satisfied and r satisfies the newcond).

As the selection method, processing is performed, such as determining an option in accordance with a condition determined in advance, for example, displaying options to a user and determining an inputted option.

If the option (A) is selected (step S106: (A)), then a special value (null) is substituted for w (step S107), w is outputted (step S103), and the processing is ended. Thereby, the request r is discarded.

If the option (B) is selected (step S106: (B)), then it is checked whether such a window wεW as satisfies f′(w)=p exists, where an acceptance partition is denoted by p (step S108). If such a window wεW as satisfies p exists (step S109: YES), then w is outputted (step S103), and the processing is ended. On the other hand, if such a window wεW as satisfies p does not exist (step S109: NO), then a new window w corresponding to the selected partition p is created by window creation processing (step S110), w is outputted (step S103), and the processing is ended. Thereby, the request r is handled in the partition p.

If the option (C) is selected (step S106: (C)), then the processing at and after step S108 is performed after substituting p0 for p (step S111). Thereby, the request r is handled in the partition p0.

If the option (D) is selected (step S106: (D)), then a new partition p is created first by the partition creation processing (step S112). Next, a new window w corresponding to the created partition p is created by the window creation processing (step S110), w is outputted (step S103), and the processing is ended. Thereby, the request r is handled in the new partition

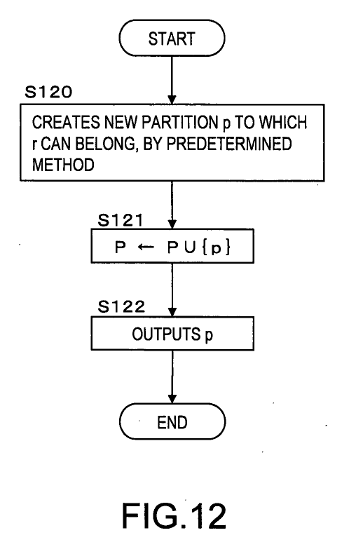

FIG. 12 shows a flowchart of the partition creation processing. The partition creation section 215 creates a new partition corresponding to a request r by the create_partition algorithm. However, it is necessary that the request r satisfies the creation conditions newcond as a precondition.

The partition creation section 215 creates a new partition p to which the request r belongs by a predetermined method (step S120). Furthermore, the created partition p is added to a set of partitions P (step S121), and p is outputted (step S122).

Specifically, such a partition pn as has a condition which makes it possible to include the request r is added to the partition table 201, and a corresponding data storage area is prepared in the short-term storage area 220 and the long-term storage area 230. A specific method for setting conditions in the partition table 201 depends on the request r and the creation conditions newcond, that is, the conditions set in the partitioning setting table 203.

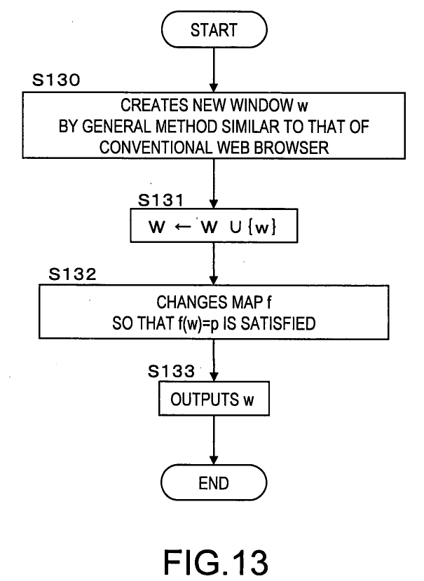

FIG. 13 shows a flowchart of the window creation processing. The window creation section 217 creates correspondence relation between a partition p and a new window w by the create_window algorithm.

When a new window w is created by the Web browser 200 in an existing processing method (step S130), the window creation section 217 adds the created window w to a set of windows W (step S131). Furthermore, in order to associate the window w with the specified partition p, the map f is changed so that f(W)=P is satisfied (step S132), and w is outputted (step S133). Specifically, a new row is added to the window table 205, and w and p are set.

Next, the partition creation processing will be described in more detail.

The partition creation section 215 is provided with the function of being triggered by HTTPS, the function of being triggered by a cookie, the function of being triggered by HTTP authentication and the function of being triggered by a password field, and the partition creation processing is performed by each of the functions as follows.

It is assumed that a new partition identifier is appropriately determined so that it does not correspond to another partition identifier. It is assumed that, as for the storage position in the long-term storage, a relative pathname based on the partition identifier is appropriately determined and, as for the storage position in the short-term area, an offset to the memory area which can be newly used is appropriately determined.

Before actually creating a partition, information about how the partition creation processing is performed may be presented to a user so as to prompt the user to determine whether or not to execute the partition creation processing, whether or not to refuse request transmission and the like.

(1) Partition Creation Processing by the Function of Being Triggered by HTTPS

The partition creation section 215 newly creates a partition by applying the function of being triggered by HTTPS only when the protocol name of the URL of a request r is “https”.

The contents of a created partition will be shown below. This means that, when a request to an HTTPS protocol site is attempted, a partition which can include requests to the site is created.

Expiration time and date: “volatile”

URL protocol condition: “https”

URL hostname condition: the same as the destination hostname of the request r

URL port number condition: the same as the specified destination port number of the request r; and if specification is not given, “default”

URL path condition: “*”, or a prefix portion is automatically copied from the path of the requested URI of the request r and applied (which is to be used is determined by the user's determination or in accordance with presettings)

Trigger cookie condition: “n/a”

Trigger HTTP authentication condition: “n/a”

(2) Partition Creation Processing by the Function of Being Triggered by a Cookie

When the name of any cookie to be transmitted accompanying a request r corresponds to the cookie name pattern in the partitioning setting table 203, the partition creation section 215 applies the function of being triggered by a cookie to newly create a partition. To describe the example of the partitioning setting table 203 shown in FIG. 6, this is applied to such a request that a cookie, for example, with the name of “JSESSIONID” is transmitted.

The contents of the created partition will be shown below. This means that, if a request is attempted by attaching a cookie with a specified name, a partition including requests by which the cookie can be transmitted is created.

Expiration time and date: the same as that of the cookie concerned; and if it does not exist, “volatile”

URL protocol condition: “https” if the cookie concerned has the secure attribute; and otherwise, “*”

URL hostname condition: the same as the applicable domain for the cookie concerned; and if it does not exist, the same as the destination hostname of the request r

URL port number condition: the same as the applicable port number for the cookie concerned; if it does not exist, the same as the specified destination port number of the request r; and if it does not exist either, “default”

URL path condition: the same as the applicable path for the cookie concerned; and if it does not exist, “*”

Trigger cookie condition: a list separated with semicolons and constituted by the name of the cookie concerned, applicable domain, applicable port number, applicable path and presence/absence of the secure attribute

Trigger HTTP authentication condition: “n/a”

(3) Partition Creation Processing by the Function of Being Triggered by HTTP Authentication

When an authorization HTTP header field exists in a request r, the partition creation section 215 applies the function of being triggered by HTTP authentication to create a partition.

The contents of the created partition will be shown below. This means that, if request transmission accompanied by authentication information for HTTP authentication is attempted, a partition corresponding to the kind and range of the authentication realm and the user ID is created.

Expiration time and date: “volatile”

URL protocol condition: the same as the protocol name of the request r

URL hostname condition: the same as the destination hostname of the request r

URL port number condition: the same as the destination port number of the request r; and if it does not exist, “default”

URL path condition: the same as the path to the HTTP authentication realm corresponding to the authorization header to be transmitted

Trigger cookie condition: “n/a”

Trigger HTTP authentication condition: a list separated with semicolons and constituted by the kind of HTTP authentication (“basic” or “digest”), realm name, user ID of authentication information and realm pathname which have been obtained from the corresponding HTTP authentication realm and authentication information

(4) Partition Creation Processing by the Function of Being Triggered by a Password Field

When a parameter (of a query or a form) acquired from the password field of an HTML form is included in a request r, the partition creation section 215 applies the function of being triggered by HTTP authentication to newly create a partition. The password field refers to a field (input item) formed by an INPUT tag whose type attribute has a value “password”.

The contents of the created partition will be shown below. This means that, if a request including the value of a password field (in most cases, a password for authentication) is attempted, a partition including requests to the site is created.

Expiration time and date: “volatile”

URL protocol condition: the same as the protocol name of the request r, or “*” (which is to be used is determined by the user's determination or in accordance with presettings)

URL hostname condition: the same as the destination hostname of the request r

URL port number condition: the same as the destination port number of the request r; and if it does not exist, “default”

URL path condition: “*”, or a prefix portion is automatically copied from the path of the requested URI of the request r and applied (which is to be used is determined by the user's determination or in accordance with the presettings)

Trigger cookie condition: “n/a”

Trigger HTTP authentication condition: “n/a”

(5) Partition Creation Processing Triggered by Receiving of a Cookie

The above methods (1) to (4) are for creating a new partition when a request is transmitted. However, the partitioning management section 210 can also create a partition at a different timing.

The partition creation processing triggered by receiving of a cookie is performed only when the partitioning triggered by a cookie in the partitioning setting table 203 in FIG. 6 is enabled, the response has a Set-Cookie or Set-Cookie2 header, and the name of the cookie specified by the header corresponds to the cookie name pattern.

When receiving a particular response, the partition creation section 215 determines the creation conditions newcond. If creation is necessary, it newly creates a partition based on the create_partition algorithm and describes a method for handling a response in the partition table 201. Information about the created partition is the same as in the case of the partition creation processing by the function of being triggered by a cookie performed when a request is transmitted.

The window creation section 217 creates information for associating the new partition with a window created by the Web browser 200 by the create_window algorithm.

Thereby, when a cookie is issued from a server, isolation by the partition can be performed.

(6) Partition Creation Processing by Receiving of a Cookie and the Use of a Server Specified Attribute

If, in the partition creation processing in (5) described above, issue of a session cookie which means the start of important processing is specified by the server side, the partition creation processing can be performed more certainly.

Accordingly, the partition creation processing by receiving of a cookie and the use of a server specified attribute is performed only when the attribute of session=true is specified for the cookie, in addition to the method of determining the Set-Cookie or Set-Cookie2 header in a response from the server.

Next, request editing processing will be described.

The request editing section 219 of the partitioning management section 210 can arbitrarily change the contents of a request before transmitting the request. The contents of a request may be automatically changed in accordance with predetermined rules or may be edited by interactive operations by a user.

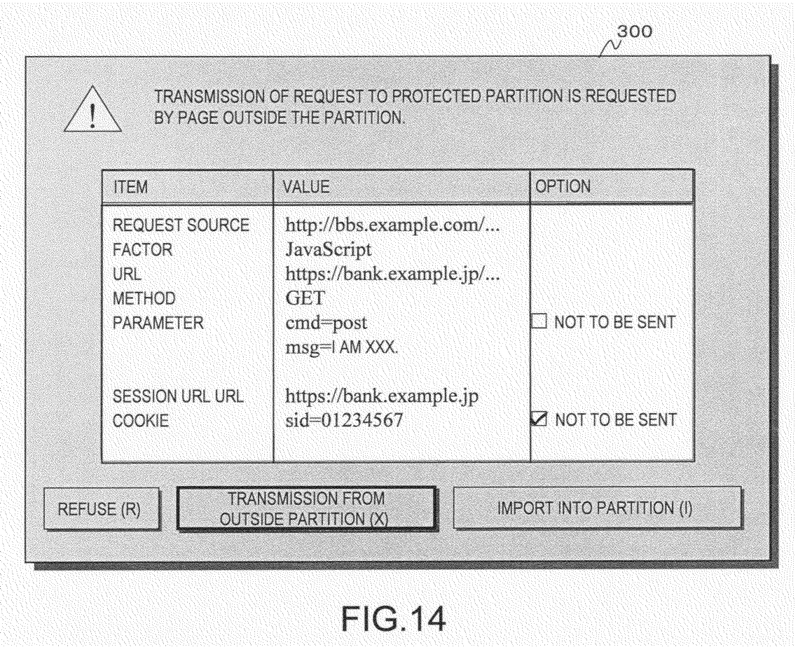

FIG. 14 shows an example of a screen for interactive operations by a user. If, for a certain partition, request transmission to the access destination of the partition is requested from the outside, then the partitioning management section 210 displays a screen 300, notifies the user of the existence of request transmission beyond the partition to cause the user to select predetermined processing. For example, the user is caused to select whether to refuse the request transmission by selecting and operating an (R) button provided in the screen 300, to transmit the request outside the partition (for example, with the partition p0) by selecting and operating an (X) button or to import the information of the request into the partition by selecting and operating an (I) button.

Furthermore, a check field to indicate “not to be transmitted” is provided in the screen 300 as an optional item. When the user puts a checkmark in this check field in the screen 300, the information attached with the checkmark is deleted from the contents of the request to be transmitted, and the request with the edited contents is transmitted.

Refusal of request transmission and selection of a partition to be accepted are performed by the partition boundary check processing. Furthermore, since a parameter of a request which may damage the user is deleted or changed by the request editing processing, it is possible to transmit only a safer request and attempt access.

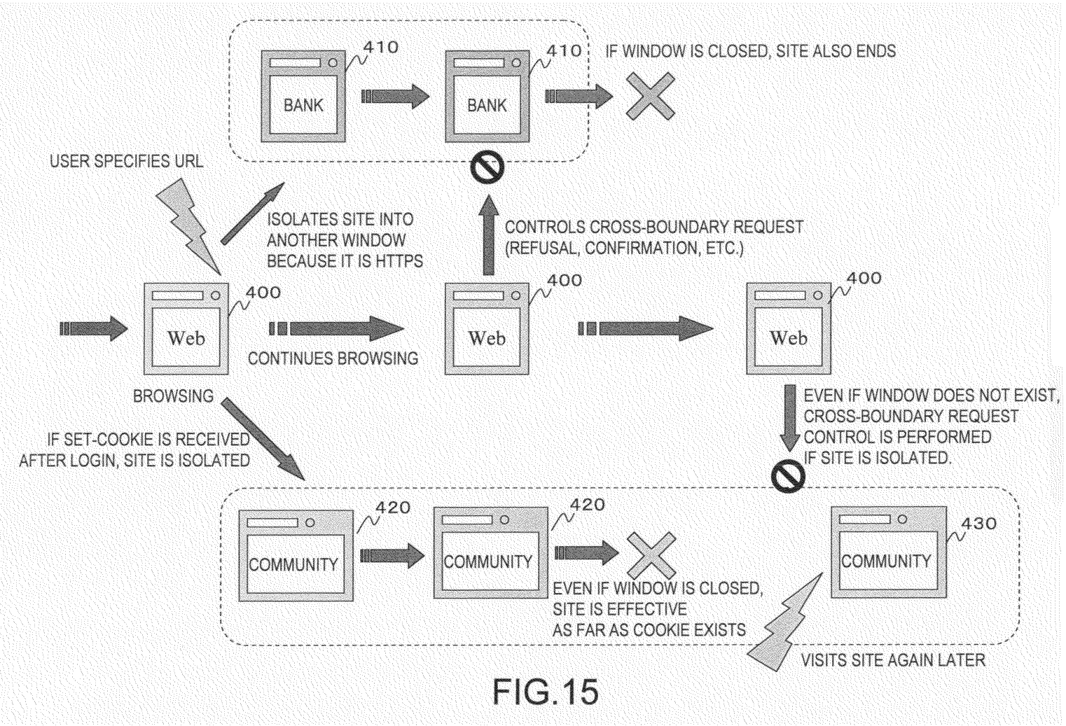

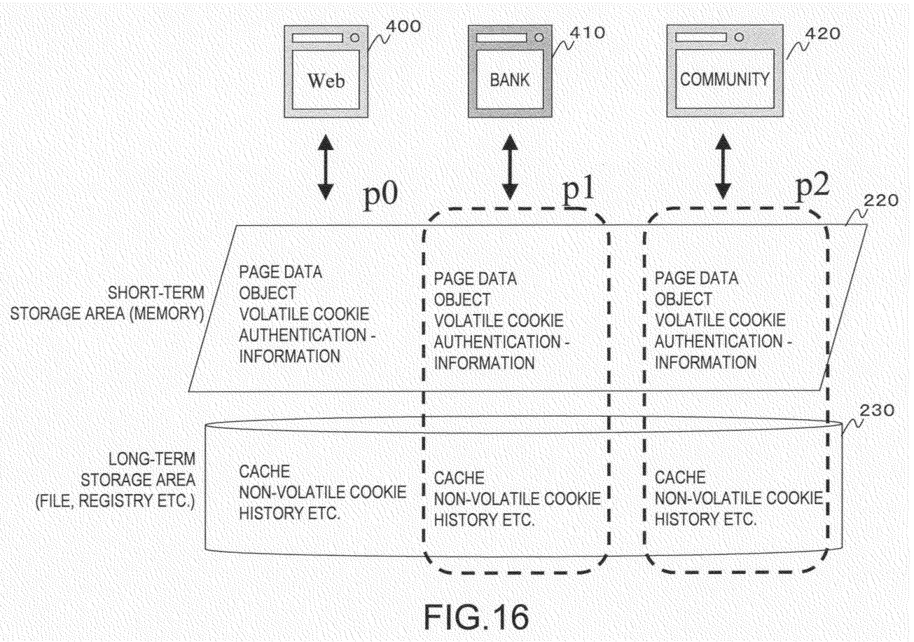

The operation of the present invention will be described with the use of FIGS. 15 and 16.

It is assumed that the Web browser 200 displays a certain Web page x on a window 400 (partition p0) as shown in FIG. 15.

While browsing Web pages on the window 400, a user specifies a different URL (bank) by an input or a bookmark. When request transmission is requested by the specification of the different URL, the partition boundary check processing is performed. If the protocol name of the request which has been requested to be transmitted is “HTTPS”, then a different window 410 is generated based on this request transmission. Furthermore, a partition pl is generated by the partition creation processing triggered by HTTPS, and the window 410 is isolated.

Thereby, the Web page (page of a bank) of the URL (bank) is displayed in the new window 410, and subsequent requests are handled in the window 410 as far as the access destination is the same.

As shown in FIG. 16, short-term storage data (page data, objects, volatile cookies, authentication information and the like) and long-term storage data (caches, non-volatile cookies, histories and the like) handled in the isolated window 410 are isolated in areas secured in the short-term storage area 220 and the long-term storage area 230, respectively.

Suppose that, while the window 400 and the window 410 are displayed by the Web browser 200, a request to the access destination (bank) of the window 410 is requested by the access destination of the window 400 as the request source. It is determined by the partition boundary check processing that this request transmission is such as goes beyond a partition, and the Web browser 200 can control request transmission which is not desired by the user, by automatically refusing the request transmission or making a notification to the user to confirm whether or not to perform the transmission.

Information of the partition pl corresponding to the window 410 is also isolated from the processing handled by external windows, for example, the window 400.

It is assumed that the user subsequently logs in a community site while browsing Web pages on the window 400. The partition boundary check processing is performed in response to the login request transmission, and a different window 420 is generated. When a response having Set-Cookie is received after the login, a partition p2 is generated by the partition creation processing triggered by receiving of a cookie, and the window 420 is isolated.

Thereby, the Web page (community site) is displayed in the new window 420, and subsequent requests are handled in the window 420 as far as the access destination is the same.

The community site is such a site as the user may visit again. Even after the window 420 is closed, the partition p2 corresponding to the window 420 is held as an effective setting, and information such as cookies is isolated and stored in the long-term storage area 230 corresponding to the partition p2.

Suppose that, after the window 420 is closed, a request to the access destination (community site) of the window 420 is requested by the access destination of the window 400 as the request source. It is determined by the partition boundary check processing that this request transmission is such as goes beyond a partition, and the Web browser 200 controls request transmission which is not desired by the user, by automatically refusing the request transmission or making a notification to the user to confirm whether or not to perform the transmission.

When the user visits and logs in the community site again later, a window 430 is created, the partition p2 is associated therewith, and isolation is similarly performed. The window 430 can use the information isolated as that of the partition p2 the same as before.

In this embodiment, if appropriate information is set in the partition table 201 in advance, the partitioning management section 210 can check a request r and determine a partition in the partition boundary check processing using only the partition table 201 and the window table 205. In this case, the partitioning setting table 203 is not used, and the creation conditions newcond are not specified. Therefore, a new partition is not created.

By providing the partitioning setting table 203 and setting the creation conditions newcond, a partition is automatically created at a suitable timing without a user being required to set information in the partition table 201 in advance, and the convenience is enhanced more.

The present invention has been described with the use of an embodiment thereof. It is natural that various variations of the present invention are possible within the range of the spirit.

What is claimed is:

1. A request transmission control program product for, in order to control request transmission in communication protocol processing, causing a computer to function as a control apparatus comprising:
a partition information storage unit for storing, as a condition for belonging to each of one or more partitions for classifying access destinations of request transmission, partition information in which all or a part of location information about the access destination belonging to the partition is set;
a partitioning unit for, when request transmission is instructed, identifying a partition to which the access destination of the request transmission belongs based on the partition information;
a request determination unit for determining the request source of the request transmission and, if the request transmission is requested by a response or body contents acquired from an access destination which does not belong to the partition of the access destination of the request transmission, determining the request to be a cross-boundary request; and
a request transmission control unit for refusing transmission of the cross-boundary request.

2. The request transmission control program product according to claim 1, causing the computer to function as the control apparatus wherein the request transmission control unit notifies a user of transmission of the cross-boundary request, and transmits the cross-boundary request if permission of the transmission is given.

3. The request transmission control program product according to claim 1, causing the computer to function as the control apparatus comprising a request editing unit for changing a part of information included in the cross-boundary request; wherein
the request transmission control unit transmits the edited cross-boundary request.

4. The request transmission control program product according to claim 1, causing the computer to function as the control apparatus comprising a data storage unit for isolating and storing information used in association with an access destination in an area assigned to the partition to which the access destination belongs; wherein
when performing request transmission to the access destination, the request transmission control unit uses the information isolated in the area in the partition to which the access destination- belongs.

5. The request transmission control program product according to claim 1, causing the computer to function as the control apparatus comprising a partitioning setting information storage unit for storing partitioning setting information in which a condition for executing partitioning for classifying an access destination is set; wherein
the partitioning unit classifies the access destination of request transmission based on the partitioning setting information and, if the access destination does not correspond to any of the partition information, creates a new partition corresponding to the access destination, and adds the condition for belonging to the created partition to the partition information.

6. The request transmission control program product according to claim 5, causing the computer to function as the control apparatus wherein, in the partitioning setting information, it is set as a condition that, when a session cookie is issued from the access destination of executed request transmission, a partition having a belonging condition corresponding to the effective range of the session cookie is created being triggered by the issue.

7. The request transmission control program product according to claim 5, causing the computer to function as the control apparatus wherein, in the partitioning setting information, it is set as a condition that, when authentication is requested from the access destination of executed request transmission, a partition having a belonging condition corresponding to the range of the authentication is created being triggered by the authentication request.

8. The request transmission control program product according to claim 5, causing the computer to function as the control apparatus wherein, in the partitioning setting information, it is set as a condition that, when a response including a password field is obtained from the access destination of executed request transmission, a partition having a belonging condition corresponding to any of the access destination from which the response has been obtained and the access destination to which the request is to be transmitted is created being triggered by transmission of a request including data in which a value is inputted in the password field.

9. A request transmission control apparatus for controlling request transmission in communication protocol processing, comprising:
a partition information storage unit for storing, as a condition for belonging to each of one or more partitions for classifying access destinations of request transmission, partition information in which all or a part of location information about the access destination belonging to the partition is set;
a partitioning unit for, when request transmission is instructed, identifying a partition to which the access destination of the request transmission belongs based on the partition information;
a request determination unit for determining the request source of the request transmission and, if the request transmission is requested by a response or body contents acquired from an access destination which does not belong to the partition of the access destination of the request transmission, determining the request to be a cross-boundary request; and
a request transmission control unit for refusing transmission of the cross-boundary request.

10. The request transmission control apparatus according to claim 9, wherein the request transmission control unit notifies a user of transmission of the cross-boundary request, and transmits the cross-boundary request if permission of the transmission is given.

11. The request transmission control apparatus according to claim 9, comprising a request editing unit for changing a part of information included in the cross-boundary request; wherein
the request transmission control unit transmits the edited cross-boundary request.

12. The request transmission control apparatus according to claim 9, comprising a data storage unit for isolating and storing information used in association with an access destination in an area assigned to the partition to which the access destination belongs; wherein
when performing request transmission to the access destination, the request transmission control means uses the information isolated in the area in the partition to which the access destination belongs.

13. The request transmission control apparatus according to claim 9, comprising a partitioning setting information storage unit for storing partitioning setting information in which a condition for executing partitioning for classifying an access destination is set; wherein
the partitioning unit classifies the access destination of request transmission based on the partitioning setting information and, if the access destination does not correspond to any of the partition information, creates a new partition corresponding to the access destination, and adds the condition for belonging to the created partition to the partition information.

14. A method for a computer to control request transmission in communication protocol processing, comprising:
a data access processing step of accessing partition information storage means for storing, as a condition for belonging to each of one or more partitions for classifying access destinations of request transmission, partition information in which all or a part of location information about the access destination belonging to the partition is set;
a partitioning processing step of, when request transmission is instructed, identifying a partition to which the access destination of the request transmission belongs based on the partition information;
a request determination processing step of determining the request source of the request transmission and, if the request transmission is requested by a response or body contents acquired from an access destination which does not belong to the partition of the access destination of the request transmission, determining the request to be a cross-boundary request; and
a request transmission control step of refusing transmission of the cross-boundary request.

15. The request transmission control method according to claim 14, wherein the request transmission control step notifies a user of transmission of the cross-boundary request, and transmits the cross-boundary request if permission of the transmission is given.

16. The request transmission control method according to claim 14, comprising a request editing step of changing a part of information included in the cross-boundary request; wherein
the request transmission control step transmits the edited cross-boundary request.

17. The request transmission control method according to claim 14, comprising a second access processing step of accessing data storage means for isolating and storing information used in association with an access destination in an area assigned to the partition to which the access destination belongs; wherein
when performing request transmission to the access destination, the request transmission control step uses the information isolated in the area in the partition to which the access destination belongs.

18. The request transmission control method according to claim 14, comprising a third access processing step of accessing partitioning setting information storage means for storing partitioning setting information in which a condition for executing partitioning for classifying an access destination is set; wherein
the partitioning step classifies the access destination of request transmission based on the partitioning setting information and, if the access destination does not correspond to any of the partition information, creates a new partition corresponding to the access destination, and adds the condition for belonging to the created partition to the partition information.
